(19) United States
(12) Patent Application Publication
(10) Pub. No.: US 2013/0327319 A1
(43) Pub. Date: Dec. 12, 2013

(54) Process for the Mechanical or Mechano-Chemical Pretreatment of Biomass

(71) Applicants: Kirsi Immonen, Tampere (FI); Eino Sivonen, Espoo (FI); Kyosti Valta, Tampere (FI); Anne Kallioinen, Espoo (FI); Matti Siika-Aho, Espoo (FI)

(72) Inventors: Kirsi Immonen, Tampere (FI); Eino Sivonen, Espoo (FI); Kyosti Valta, Tampere (FI); Anne Kallioinen, Espoo (FI); Matti Siika-Aho, Espoo (FI)

(73) Assignee: TEKNOLOGIAN TUTKIMUSKESKUS VTT, VTT (FI)

(21) Appl. No.: 14/000,402

(22) PCT Filed: Feb. 23, 2012
(86) PCT No.: PCT/FI2012/050187

§ 371 Date: Aug. 20, 2013

(30) Foreign Application Priority Data
Feb. 25, 2011 (FI) 20115186

(51) Int. Cl. C08B 1/00

(52) U.S. Cl. CPC C08B 1/00
USPC 127/34

(57) ABSTRACT

The present invention concerns a process for the mechanical or mechano-chemical treatment of biomass, wherein a mixture containing the biomass and optional further chemicals is pressed through the openings of one or more compactor one or more times. The process can be operated in a continuous manner by using more than one compactor and more than one compacting cycle, whereby the multiple compactors are operated sequentially.

### BACKGROUND OF THE INVENTION

1. Field of the Invention

The present invention relates to a process for the mechanical or mechano-chemical treatment of biomass, according to the preamble of claim 1.

Particularly, the invention relates to a mechano-chemical pre-treatment of lignocellulosic biomass, to cause degradation and fibrillation of the cellulosic material and make it more suitable for further use in subsequent processes, such as hydrolysis.

2. Description of Related Art

In the processing of lignocellulosic materials into various products, the starting material is usually pre-modified using methods requiring high water contents, which allows fiber separation when mechanical energy and shearing forces are introduced into the system. The high water or solvent content, however, gives a material that needs several processing steps before the actual goal of the modification is achieved. Residual water and solvents are also often ranked as problem waste in such processes, which solvents then need to be purified or disposed.

In the development of new technologies for providing renewable resources for subsequent use in energy production and in the conversion of lignocellulosic materials into new products, more cost-effective, energy efficient and low-solvent-consuming environmental friendly methods are sought.

Bioconversion of lignocellulosic biomass to ethanol and other valuable products has been under investigation for decades. Recently, the area has received growing interest and trials of large-scale production have been launched. In the production of ethanol and other chemicals from biomass, it would be advantageous to enhance the enzymatic activity in the lignocellulosic material by modification. For this purpose, different kinds of chemical (including enzymatic) and mechanical pre-treatment methods have been developed, such as steam explosion and wet oxidation, as described in, e.g. EP1259466.

However, methods, such as the mentioned steam explosion, are expensive, they waste energy, and they can cause the formation of by-products which are detrimental to further processing.

Thus, dry modification methods have been developed (or methods utilizing very low contents of solvent). These include mainly different physical modifications, such as different milling methods, plasma or corona modifications, or vapor or heat treatments.

Dry compacting/pelletizing has been found advantageous. However, with many types of commercial equipment, it is commonly known that some materials easily block the material flow by creating a material wedge in front of the rollers of the equipment. This prevents the free rotation of the rollers, generates excess friction between the material and the pan plate and thus starts to burn the material. These phenomena quickly dry the material and the problem gets dynamically worse. Finally, the compacting process must be halted and the pan plate must be cleaned by drilling or some other time-consuming method.

Thus, there is still a need for dry modification/treatment methods, utilizing low contents of solvents, being simple and quick, and being environmentally friendly.

### SUMMARY OF THE INVENTION

It is an object of the present invention to provide a mechanical or mechano-chemical treatment method for biomass, which method requires the use of minimal amounts of solvents.

Particularly, it is an object of the present invention to provide such a dry biomass treatment method, which is suitable for use in an industrial-scale for lignocellulosic biomass intended to be further processed into commercial products, such as biofuel.

Another particular object of the invention is to provide a pre-treated, relatively dry biomass material that has a maximum surface area capable of taking part in any subsequent processing.

These and other objects, together with the advantages thereof over known methods and processes, are achieved by the present invention, as hereinafter described and claimed.

Thus, the present invention concerns a process for the mechanical or mechano-chemical treatment of biomass.

The most significant embodiment of the invention is a dry process for the treatment of the biomass, to be used, for example, as an initial step in an energy production process (e.g. a biofuel production process).

More specifically, the process of the present invention is characterized by what is stated in the characterizing part of claim 1.

The invention provides a new type of solution for the pre-treatment of lignocellulosic biomass, intended to precede for example the enzymatic hydrolysis of said biomass for the purpose of the production of biofuel (e.g. ethanol).

Considerable advantages are obtained by means of the invention. Thus, the process of the invention can be used in a continuous manner, and either without added solvent, or with very small volumes of added solvent, whereby the process can easily be scaled up to industrial scales.

Further, the present invention provides an energy-efficient and cost-effective manner of manufacturing, for example ethanol or other similar chemicals via the carbohydrate-route, to satisfy the demands of, among others the fuel and energy industries. This is due to the possibility to apply the mechano-chemical pre-treatment of the present invention to enhance the enzymatic total hydrolysis of lignocellulosic biomass. The hydrolysis results (conversion levels of carbohydrates) obtained using this process are comparable to the results obtained with steam explosion, which is one of the state-of-the-art pre-treatment technologies. However, compared to steam-explosion this new mechano-chemical process utilizing a dry-compactor consumes smaller amounts of solvents, is energy efficient and is easy to scale up to production scale.

Thus, the present invention has demonstrated a possibility for use, not only in dry-processing methods using the subsequently described e-compacting technology, but also in joined enzymatic and dry-processing methods. As soon as the dry material content in the enzymatic processing can be increased to a level of >50%, these two treatments can be combined to provide a new environmental friendly processing option for several biomass modification processes, such as hydrolysis.

Next, the invention will be described more closely with reference to the attached drawings and a detailed description.

### BRIEF DESCRIPTION OF THE DRAWINGS

FIG. 1 is a photograph of a laboratory-scale e-compactor that can be utilized in the process of the present invention.

FIG. 2 is a microscope-image of biomass (here spruce chips), before treatment (FIG. 2a), and after the treatment according to the present invention using 10 compacting-cycles (FIG. 2b).

FIG. 3 is a graphical presentation of the enzymatic hydrolysability of spruce chips and TMP treated according to the present invention, compared to steam-exploded spruce.

### DETAILED DESCRIPTION OF THE PREFERRED EMBODIMENTS OF THE INVENTION

The present invention concerns a process for the mechanical or mechano-chemical treatment of biomass, wherein the mixture containing the biomass and optional further chemicals is pressed through the openings of one or more compactor one or more times.

Essentially, the process is can be used as a mechano-chemical pretreatment of lignocellulosic biomass prior to an enzymatic total hydrolysis and an ethanol production process, and includes dry compacting. Further, the process makes it possible to mix active chemicals, such as oxidative chemicals, alkali or acid into the mass in conditions that are as dry as possible, with the dry matter content being 30-99.9%, or e.g. 55-99.9%, in an environmentally friendly manner, without excess solvent.

During said treatment, the lignocellulosic fibers of the biomass are broken down and the fiber surfaces are fibrillated, turning the subsequent processing step(s), e.g. enzymatic hydrolysis towards sugars and the ethanol process, as efficient as possible.

The biomass is preferably lignocellulosic biomass, particularly intended to mean cellulose-containing biomass further containing even small traces of lignin. Preferably, the biomass is selected from raw-materials, such as cellulose pulp, such as dissolving pulp, mechanical mass, wood chips, such as spruce chips, and reed canary grass.

According to an embodiment of the invention, suitable raw-materials also include other cellulose-containing plant material, such as wood from softwood trees, e.g. spruce, pine, fir, larch, douglas-fir or hemlock , or wood from hardwood trees, e.g. birch, aspen, poplar, alder, eucalyptus or acasia, or non-wood materials, such as agricultural residues, or grasses, straw, leaves, bark, seeds, hulls, flowers, vegetables or fruits from materials, such as cotton, corn, wheat, oat, rye, barley, rice, flax, hemp, manila hemp, sisal hemp, jute, ramie, kenaf, bagasse, bamboo or reed. These can be used as such or as mixtures of two or more of these mentioned wood or non-wood raw-materials. These can optionally be processed prior to use by, for example, mechanical or chemimechanical pulping, more particularly by, e.g., refiner mechanical pulping (RMP), pressurized refiner mechanical pulping (PRMP), thermomechanical pulping (TMP), groundwood (GW) or pressurized groundwood (PGW) or chemithermomechanical pulping (CTMP).

One or more further chemicals can be added to the biomass prior to compacting, particularly in the form of active chemicals. The used active chemicals can include catalysts, alkalis and acids, as well as oxidative agents. The addition preferably takes place by spraying. Most suitably, the active chemical(s) are added in dry form (as powders) or in a solution (aqueous or other solution), the solution most suitably being in a concentrated form.

According to an embodiment of the invention, the further chemicals are added during compacting, whereby they are added into the compactor, without prior mixing with the biomass.

Particularly preferred further chemicals are sodium hydroxide (NaOH), hydrogen peroxide (H₂O₂), H₂O₂ mixed with cobalt, sulfuric acid (H₂SO₄) or sodium persulfate (Na-persulfate), most suitably a concentrated solution of sodium hydroxide (particularly 25-% NaOH).

According to an embodiment of the invention, particularly preferred further chemicals also include various enzymes (particularly oxidative enzymes), other peroxides, sodium carbonate and peracetic acid, as well as water.

The process utilizes compacting equipment, such as the e-compactor described in FI20106340. This e-compactor is a modified pelletizing equipment, which can be used as a pre-treatment technology for several kinds of organic materials.

A compactor, in general, is a type of equipment that is used to increase the specific weight of the biomass, specifically by compounding, mixing and homogenizing the material. Such compactors are commonly used in the feed, food and mining industries, as well as in the manufacture of energy pellets, and in the compacting of waste plastic into granulate.

The e-compactor described in FI20106340 functions by an angular roller of the compactor pressing the material to be processed against a perforated pan plate, whereby more material is continuously pressed through the holes of the plate.

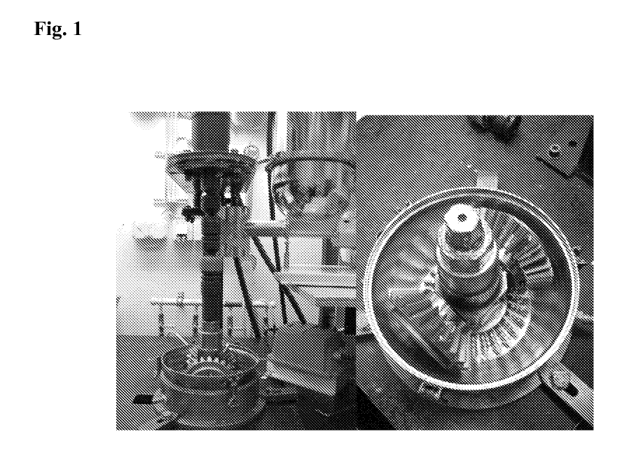

Thus, according to an embodiment of the present invention, the process includes the steps, wherein biomass material is pressed through the openings in a perforated pan plate of a compactor, such as the one described in FI20106340, with the help of the rollers of a roller mill (see FIG. 1), whereby both the pressure and the temperature of the material is increased, and the material is pressed into pellets. The advantages of such a compactor compared to other types of equipment include a reduced amount of friction between the rollers and the plate (or the biomass material and the plate), and a remarkably improved delivery of material, and a reduced incidence of interruptions (e.g. due to the cleaning of clogged equipment). Thus, the overall function of the present process is improved using said compactor, and the range of materials that can be processed is increased (here including also dry and slippery materials).

According to an embodiment of the invention, the holes of the perforated pan plate of the compactor have a diameter of 1-5 mm, particularly about 3 mm.

In the process of the present invention, the biomass is pressed through said openings of said compactor one or more times, particularly 1-10 times, preferably 2-10 times. Many materials have been found to require compacting more than one time (in more than one cycle), particularly 5-10 times, e.g. 10 times, which pressing can be carried out as a continuous process using sequential compactors. The optimum exact number of compacting cycles, however, depends on the type of biomass used (e.g. the size of the lumps or particles contained in it). It is, however, preferred to minimize the number of cycles.

During the compacting, the temperature of the biomass is slightly increased, with a maximum temperature being about 70° C., said increased temperature further activating the optionally added chemicals.

Each compacting cycle causes a further increase of the temperature, whereby, according to an embodiment of the invention, the number of cycles can be increased up to 20, with monitoring of the temperature. Generally, the number of cycles is minimized and can be selected according to the lump/particle size of the biomass raw-material, preferably with a more homogenous pulp subjected to 1-5 cycles, most suitably 1-2 cycles, and with chips, husks and other types of non-homogenized materials subjected to 5-10, or even 5-20, cycles.

Also, the compactor creates local and transient high pressure, shear and elongational deformations in the material system together with a high temperature gradient. In fact, the advantages of the invention include the possibility to process the biomass at low temperatures, low pressures and during short/limited periods of time. This also generates and maintains useful chemical reactions.

The production output of the described e-compactor is very high, e.g. about 180 kg/h, when similar outputs using standard laboratory equipment configurations, according to one example, give results of about 27 kg/h.

After compacting, the excess of optionally added further chemicals is washed using water, and thus filtered off the biomass prior to the optional subsequent processing steps, such as enzymatic hydrolysis.

According to an alternative procedure, the added further chemicals are not removed, but the treated biomass mixture is merely subjected to a pH adjustment, preferably to a pH value within the range of 6-9.

Compared to existing solvent phase technologies, the here described e-compacting can save energy and solvents, so being more environmentally suitable as pre-treatment of different lignocellulosic fiber modifications. Also compared to existing pelletizing methods, this equipment configuration allows for the compacting of natural materials using significantly less friction heat formation compared to commercial equipments.

The process allows for the addition of active chemicals to the biomass, while keeping said biomass relatively dry, since the used compactor is capable of degrading and fibrillating the fibers of the biomass without the presence of added solvent. Thus, the process and the equipment are operated at a dry-matter content of above 30%, preferably 55.0-99.9%.

Preferably, the above-mentioned high dry-matter content is achieved without the use of any added solvent, i.e. with all the solvent in the material to be compacted being traceable to the moisture of the biomass source material and any solvent of the optional further chemical(s), since fresh wood already can contain about 50% by weight of water.

The dry-compacting is an environmentally friendly alternative, which has been found to provide an equally effective overall process compared to the common steam-explosion. Further, it provides an optimized pre-treatment for the optional subsequent processing step of enzymatic hydrolysis, for example for the purpose of converting the biomass into sugars and ethanol. In enzymatic hydrolysis using lignin containing materials, the lignin retards the reaction. By effectively breaking down and fibrillating the fiber surfaces, the cellulose will be more accessible for the optional subsequent enzymatic hydrolysis or chemical modification towards cellulose derivatives. This is due to the increased surface area that the chemicals have to act on. The dry modification/compacting process enables the addition of optional chemicals that in turn are able to modify and solubilize lignin or, e.g. peroxides or other oxidizing agents, able to activate the cellulose surface together with the compacting.

The present process forms a manner of pre-treating said lignocellulosic materials prior to their further processing steps, such as hydrolysis. The present process can thus be used as a part of a more complex procedure, where fermentable sugars (carbohydrates, particularly monosaccharides) are produced from lignocellulosic materials. The fermentable sugars can be transformed via fermentation into various products, such as ethanol, organic acids, special carbohydrates and amino acids.

Alternatively, products, such as polymers and fats, can be produced.

The process of the invention can also be used as a pre-treatment stage in chemical procedures (e.g. alkaline oxidation), where the enzymatic hydrolysability of the biomass is even further improved, or in the extraction procedures of various components of biomass (e.g. hemicelluloses).

The following non-limiting examples are intended merely to illustrate the advantages obtained with the embodiments of the present invention.

### EXAMPLES

### Example 1

### Mechano-Chemical Treatment

Biomass based on various lignocellulosic raw materials was optionally first chemically impregnated with a chemical solution by spraying the chemical into the biomass in a Forberg-type mixer. Subsequently, the optionally chemically treated biomass was pressed 1-10 times through the e-compactor of FI20106340, without the addition of further solvent. Thus, the particle size of the material was decreased, the material surface was fibrillated and at the same time the material was warmed up from room temperature to max 50° C.

Subsequently, the further chemical of the optional chemical treatment was washed with hot water and filtered in a Buchner funnel to remove excess chemicals and all soluble substances.

The more precise choice of materials, chemicals and compacting cycle numbers, as well as the dry weight of the material after the above described treatments, are shown in the below Table 1.

TABLE 1
Raw material pre-treatments

| | | Mechanical | Dry weight after |
|---|---|---|---|
| Lignocellulose | Chemicals | treatment | pretreatment(%) |
| TMP | 25% NaOH | 5xE-comp | 34 |
| | 5% Na- | 10xE-comp | 38 |
| | persulfate | | |
| | 5% H₂O₂+ | 10xE-comp | 35 |
| | cobolt | | |
| | 5% H₂O₂ | 10xE-comp | 34 |
| | 10% H₂SO₄ | 5xE-comp | 30 |
| | — | — | 31 |
| | — | 10xE-comp | 34 |
| spruce chips | — | — | 40 |
| | — | 10xE-comp. | 46 |
| | 5% H₂O₂+ | 10xE-comp | 39 |
| | Cobolt | | |
| | 25% NaOH | 10xE-comp. | 45 |
| Reed canary | — | — | 52 |
| grass | | | |
| | — | 10xE-comp | 67 |

### Example 2

### Total Hydrolysis of Lignocellulose

The mechano-chemically treated materials of Example 1 were subjected to enzymatic total hydrolysis as well as analyses, to test the enzymatic hydrolysability of the washed solid fractions.

These were carried out at 1% consistency in test tubes using magnetic stirring at a temperature of 45° C. Commercial cellulase mixtures: Celluclast 1.5 L FG (Novozymes) and β-glucosidase Novozym 188 were used for the enzymatic total hydrolysis. The enzyme dosage was 10 FPU/g dry matter for cellulase and 100 nkat/g dry matter for β-glucosidase.

Hydrolyses were carried out during 48 (or 72) hours, and the remaining solids were removed by centrifugation.

### Example 3

### Effect of Chemical and Mechanical Treatments on Enzymatic Hydrolysability

The carbohydrate composition of the pretreated washed raw materials was determined based on selected samples obtained from the total acid hydrolysis of Example 2, and by analyzing the monosaccharides resulting from these hydrolyses by high performance anion exchange chromatography (HPAEC-PAD). The reducing sugars released in the enzymatic hydrolysis were monitored using the DNS method.

Results from these tests showed that all the treatments increased the enzymatic hydrolysability of TMP (data not shown). The highest hydrolysis level in 48 hours, with 30-35% of dry weight, was obtained with TMP treated chemically with NaOH, H₂O₂, or H₂O₂ with Cobolt salt, and then mechanically treated 5 or 10 times using the e-compactor. For spruce, the highest enzymatic hydrolysis level was obtained with a combined chemical (NaOH) and mechanical treatment. 50% of the pre-treated dry matter was solubilised to sugars during enzymatic hydrolysis for 72 h. The enzymatic hydrolysability of reed canary grass without chemical treatment was very low.

The effect of the e-compactor treatment on fiber can be best seen in spruce chips, giving the highest enzymatic hydrolysis level (80% hydrolyzed carbohydrates calculated from the total carbohydrates). According to this test procedure, spruce chips were first subjected to the chemo-mechanical treatment of Example 1 by spraying a 25-% solution of NaOH into the spruce chips and subsequently pressing the treated chips 10 times through the e-compactor of FI20106340, without the addition of further solvent.

The thus obtained pre-treated biomass was subjected to enzymatic hydrolysis during 72 hours, as described in Example 2, whereby a hydrolyzed product was obtained, having a level of hydrolysis of 80%, calculated based on the total carbohydrates.

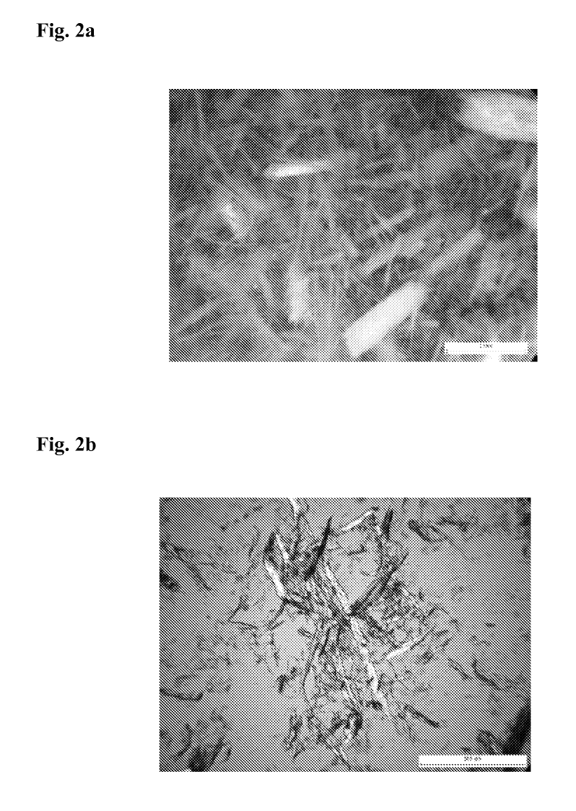

FIG. 2 presents the spruce chips before and after said 10 treatment cycles with the e-compactor

With said exemplary treatment, similar hydrolysis levels and rates were obtained, as compared to treatment with the state-of-the-art steam-explosion. However, compared to steam-explosion this new mechano-chemical process using the e-compactor consumes smaller amounts of solvents and is easily scalable to production scale. In addition, the energy consumption during the biomass processing is quite low varying from 70 to 20 kWh/t and decreasing after each treatment cycle.

In FIG. 2, it can also be seen that the e-compactor treatment can significantly reduce the size of spruce chips up to fiber level, but it also separates fibers as well as breaks the fiber surface into fibrils.

The carbohydrate composition was analysed from the washed materials giving the highest enzymatic hydrolysis levels. The polysaccharide content of these washed materials pre-treated according to the present invention was 50-62%. The glucose, i.e. cellulose, content of the pre-treated materials varied from 40% to 48% of the dry matter. In fact, it has been found that the present mechano-chemical pre-treatment enables an increase in the cellulose content of from 2 to 10%. The highest cellulose and polysaccharide content was obtained with spruce treated mechanically after a peroxide-cobolt treatment.

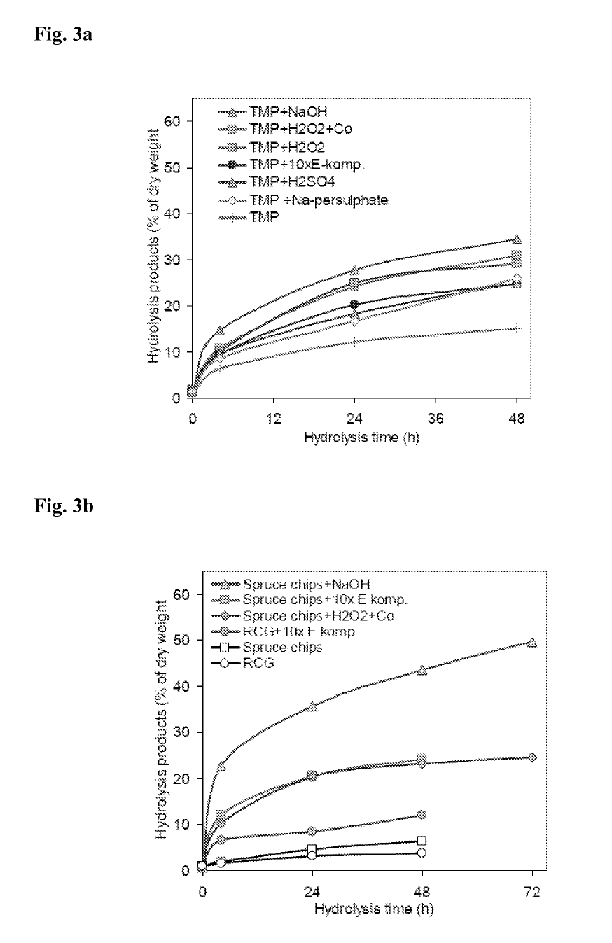

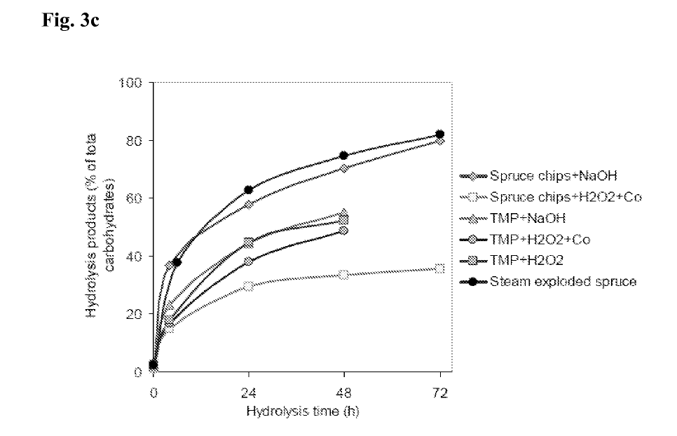

The enzymatic hydrolysability of pretreated raw materials in respect to total carbohydrate content in the hydrolysis material is presented in FIG. 3, calculated based on the total dry matter content in FIGS. 3a and 3b, and calculated based on the total content of carbohydrates in FIG. 3c.

1. A process for the mechanical or mechano-chemical treatment of biomass comprising; compacting a mixture containing the biomass by pressing it through openings of one or more compactors one or more times.

2. The process according to claim 1, wherein the biomass is a lignocellulosic biomass.

3. The process according to claim 1, wherein the biomass is selected from dissolving pulp, mechanical mass, spruce chips, and reed canary grass, or optionally from birch, aspen, poplar, alder, eucalyptus or acasia, or agricultural residues, grasses, straw, leaves, bark, seeds, hulls, flowers, vegetables or fruits from materials.

4. The process according to claim 1, further comprising adding chemicals, including one or more active chemicals, into the biomass mixture prior to compacting.

5. The process according to claim 1, further comprising adding chemicals, including one or more active chemicals selected from oxidative agents, catalysts, alkalis and acids to the biomass prior to compacting.

6. The process according to claim 1, comprising pressing the biomass through the openings of the compactor 1 time.

7. The process according to claim 1, comprising pressing the biomass through the openings of the compactor more than one time, using sequential compactors.

8. The process according to claim 1, wherein the compacting takes place by pressing the biomass against a perforated pan plate with the help of the rollers of a roller mill, whereby the biomass is degraded and fibrillated, and passes through the openings of the pan plate.

9. The process according to claim 1, wherein the temperature of the biomass is increased to above room temperature during the compacting, to a maximum temperature of 70° C.

10. The process according to claim 1, wherein a transient increased pressure, as well as shear and elongational deformations are created in the biomass-compactor system, by subjecting the biomass mixture to said compacting.

11. The process according to claim 4, wherein the compacting step is followed by a step of washing the added chemicals off the compacted biomass followed by filtering.

12. (canceled)

13. (canceled)

14. (canceled)
